(19) United States
(12) Patent Application Publication
(10) Pub. No.: US 2022/0183796 A1
(43) Pub. Date: Jun. 16, 2022

(54) METHOD FOR MANUFACTURING A FITTING DEVICE FOR AN ORTHODONTIC APPARATUS

(71) Applicant: 3C, Le Blanc-Mesnil (FR)

(72) Inventors: Patrick CURIEL, Paris (FR); Didier ERNENWEIN, Vaucresson (FR); Harry MELKA, Paris (FR); Paul COUDERC, Pantin (FR)

(21) Appl. No.: 17/546,684

(22) Filed: Dec. 9, 2021

(30) Foreign Application Priority Data
Dec. 10, 2020 (FR) 20 13000

(51) Int. Cl. A61C 7/20; A61C 9/00; A61C 7/00; A61C 7/14

(52) U.S. Cl. CPC A61C 7/20; A61C 9/0046; A61C 2201/007; A61C 7/145; A61C 7/002

(57) ABSTRACT

Disclosed is a method for manufacturing a fitting device for an orthodontic apparatus, including: the following steps: making a first image of a row of teeth in an initial position, and a second image of the orthodontic apparatus; the apparatus including two attachment elements connected by a bridge, each attachment element capable of being connected to a tooth; making a third image of the orthodontic apparatus joined to the teeth in the initial position; then making a fourth image of the fitting device, including a contact surface capable of being joined to the teeth; two complementary first cavities of the attachment elements; and a second cavity capable of receiving the bridge; then additively manufacturing the fitting device from the fourth image.

### BACKGROUND OF THE INVENTION

### Field of the Invention

The present invention relates to a method for manufacturing a fitting device for an orthodontic apparatus, of the type comprising the following steps: making a first digitized image of a row of teeth of a patient in a first initial position, said row of teeth comprising a receiving surface; then making a second digitized image of the orthodontic apparatus from said first image; said orthodontic apparatus comprising at least two attachment elements and at least one bridge, the or each bridge connecting two attachment elements, each attachment element comprising an attachment surface and an opposite front surface, each attachment surface capable of being joined to a receiving area included in the receiving surface, each receiving area corresponding to a separate tooth in the row.

The invention is particularly applicable to lingual type of orthodontic apparatus arranged on the non-visible posterior side of the teeth. The invention also applies to vestibular braces arranged on the visible front side of the teeth.

### Description of the Related Art

“Orthodontic apparatus” means an apparatus called active, capable of exerting an effort on a patient's teeth that tends to move said teeth from the initial position, considered unsatisfactory, to a desired position corresponding to an alignment of the teeth in particular; or an apparatus called inactive, capable of retaining the teeth in the initial position, following prior displacement of said teeth.

Several manufacturing techniques are known for making an orthodontic apparatus from a digitized image. Such techniques make it possible to configure the apparatus so that the parts in contact with the teeth match the shape of said teeth precisely. The manufacture of such an orthodontic apparatus is described in particular in the application FR3089114 in the Applicant's name.

However, the precise positioning of the apparatus may be beyond the capabilities of a practitioner. Small positioning errors, of the order of a fraction of a millimeter, can result in unwanted tooth movement and compromise the effectiveness of the treatment.

### SUMMARY OF THE INVENTION

In order to solve this problem, the object of the invention is a manufacturing method of the above type, further comprising the following steps: from the first and second digitized images, making a third digitized image of the orthodontic apparatus joined to the row of teeth in the first initial position, with each attachment surface of an attachment element joined to the corresponding receiving area of the receiving surface; and then making a fourth digitized image of a fitting device of the orthodontic apparatus from the third digitized image, said fitting device comprising: a contact surface capable of being assembled in a complementary way with the receiving surface of the row of teeth; at least two first cavities opening onto the contact surface, each first cavity being complementary to a front surface of an attachment element of the orthodontic apparatus; and at least one second cavity, the or each second cavity being capable of receiving a bridge of the orthodontic apparatus; and then additively manufacturing the fitting device from said fourth digitized image, using a solid material.

According to other advantageous aspects of the invention, the manufacturing method comprises one or more of the following features, taken alone or in any technically possible combination:
the manufacturing method further comprises a step of making a fifth digitized image of the patient's row of teeth in a desired second position; making the second digitized image of the orthodontic apparatus being taken based on the first and fifth digitized images, so that the orthodontic apparatus is capable of moving the patient's teeth from the first to the second position;
the fourth digitized image of the fitting device is configured such that said fitting device comprises a plurality of assembly units, each assembly unit being arranged proximate to a first cavity, each assembly unit being intended to be assembled with a corresponding attachment element in said first cavity.

The invention further relates to a fitting device resulting from a manufacturing method as described above.

The invention further relates to a method for manufacturing a fitting assembly, said fitting assembly comprising an orthodontic apparatus and a fitting device reversibly connected to each other, the method comprising the following steps: manufacturing the fitting device by a method as described above; manufacturing the orthodontic apparatus from the second digitized image; and assembling said orthodontic apparatus to the fitting device, with the front surface of each attachment element being received in the corresponding first cavity, each bridge being received in the corresponding second cavity.

Advantageously, said method further comprises assembling a holding member with each assembly unit of the fitting device, said holding member being capable of holding an attachment element of the orthodontic apparatus in the corresponding first cavity of the fitting device.

The invention further relates to a fitting assembly resulting from a manufacturing method as described above.

Advantageously, the orthodontic apparatus of the fitting assembly is a lingual type apparatus, intended to be applied to the back of a patient's teeth.

Advantageously, the orthodontic apparatus of the fitting assembly is made of a memory shaped material, preferably nitinol.

### BRIEF DESCRIPTION OF THE DRAWINGS

The invention will be better understood from the following description, given only as a non-limiting example and made with reference to the drawings in which:

FIG. 1 is a view from above of a first, three-dimensional, digitized image, forming one step of a manufacturing method according to one embodiment of the invention;

FIG. 2 is a cross-sectional detail view of the first digitized image of FIG. 1;

FIG. 3 is a view from above of a second three-dimensional digitized image forming another step of the manufacturing method;

FIG. 4 is a detail view of the second digitized image of FIG. 3;

FIG. 5 is a detail view of a fitting assembly resulting from a manufacturing method according to one embodiment of the invention; and

FIG. 6 is a flow chart of the steps of a manufacturing method according to one embodiment of the invention.

### DESCRIPTION OF THE PREFERRED EMBODIMENTS

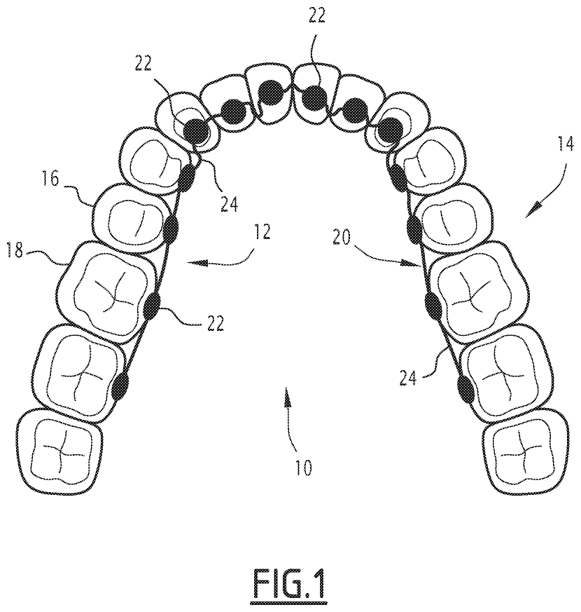

FIG. 1 shows a first three-dimensional digitized image 10 showing an orthodontic apparatus 12 joined to a row 14 of a patient's teeth 16, 18.

The orthodontic apparatus 12 is configured to be joined to a receiving surface 20 of the row 14 of teeth. In the embodiment shown, the receiving surface 20 is on the posterior side of the teeth 16, 18. In other words, the orthodontic apparatus 12 is a lingual type device.

In a variant embodiment not shown, the receiving surface is on the visible front side of the teeth, with the orthodontic apparatus being of the so-called vestibular type.

The orthodontic apparatus 12 comprises a plurality of attachment elements 22 and a plurality of bridges 24. The attachment elements 22 and bridges 24 are arranged in an alternating fashion along the orthodontic apparatus 12, with each bridge 24 connecting two adjacent attachment elements 22.

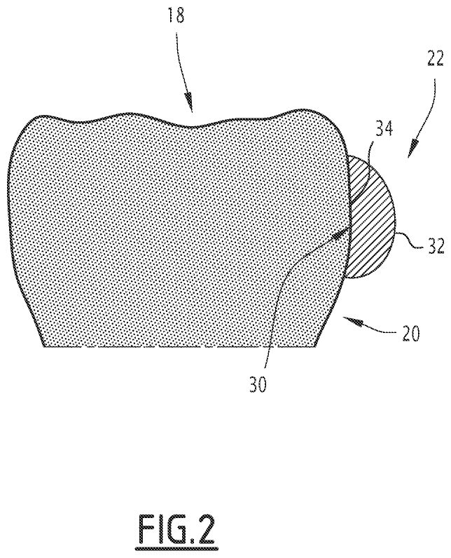

Each attachment element 22 of the orthodontic apparatus 12 is intended to be attached to a separate tooth 16, 18 in the row 14. Specifically, as visible in FIG. 2, each attachment element 22 comprises one attachment surface 30 and one front surface 32, substantially opposite each other.

The attachment surface 30 is intended to be joined to a receiving area 34, included in the receiving surface 20. Each receiving area 34 associated with an attachment surface 30 is located on a separate tooth 16, 18 of the row 14.

More particularly, each attachment surface 30 has a three-dimensional shape complementary to the associated receiving area 34. This three-dimensional shape is generally irregular, particularly in the case of a lingual type orthodontic apparatus 12. In this case, the receiving area 34 is located behind the teeth.

The front surface 32, intended to be opposite the teeth 16, 18, has a shape preferably configured for patient comfort. For example, the front surface 32 has a smooth and preferably domed shape suitable for contact with the tongue of the patient.

Each bridge 24 has an elongated shape between two ends, each of said ends contacting an attachment element 22.

In the first digitized image 10, the bridges 24 are dimensioned to correspond to deformable elements, in particular flexible elements, as will be explained later. In particular, the bridges 24 are less thick than the attachment elements 22.

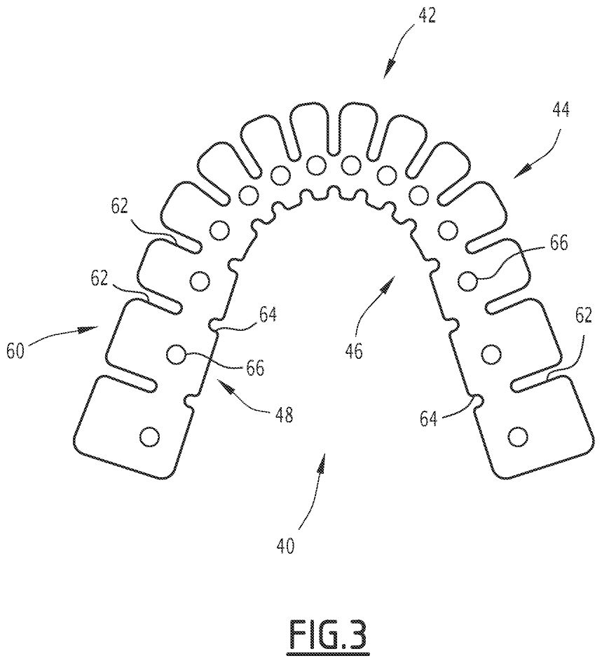

FIG. 3 shows a second digitized image 40 in three dimensions. The second image 40 shows a fitting device 42, specifically for fitting the previously described orthodontic apparatus 12.

The fitting device 42 comprises: a first side, referred to as the front surface 44 , oriented toward the row 14 of teeth; and a second side, referred to as the back side 46, opposite said row of teeth. In the embodiment shown, the fitting device 42 further comprises an assembly means 48, arranged both on the front surface 44 and on the rear surface.

In the embodiment shown, corresponding to a lingual orthodontic apparatus 12, the front surface 44 has a generally convex curved shape. In contrast, the rear surface 46 has a generally concave curved shape capable of contouring the patient's tongue.

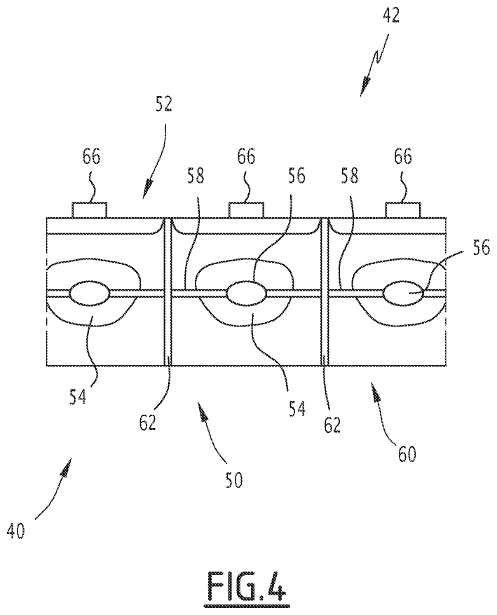

The front surface 44, the detail of which is visible in FIG. 4, includes a contact surface 50 and an insertion surface 52 in particular.

The contact surface 50 is configured to be assembled in a complementary manner with the receiving surface 20 of the row 14 of teeth. The contact surface 50 is preferably discontinuous. In particular, in the embodiment visible in FIG. 4, the contact surface 50 includes a plurality of contact areas 54 spaced apart. Each contact area 54 has a substantially annular shape and corresponds to the surface of a separate tooth 16, 18, around the receiving area 34 of an attachment element 22 of the orthodontic apparatus 12.

The insertion surface 52 is configured to be assembled to the orthodontic apparatus 12. The insertion surface 52 includes a plurality of first 56 and second 58 cavities, corresponding to the attachment members 22 and bridges 24, respectively.

Each first cavity 56 is surrounded by an annular contact area 34. Each first cavity 56 has a shape complementary to the front surface 32 of the corresponding attachment element 22. Preferably, the first cavity 56 has a concave, smooth, curved shape complementary to the curved shape of the corresponding front surface 32.

Each second cavity 58 has the shape of a groove opening onto either side of two first adjacent cavities 56. Each second cavity 58 is of sufficient size to receive a bridge 24 of the orthodontic apparatus, said bridge connecting the attachment elements 22 corresponding to said two adjacent first cavities 56.

The assembly means 48 comprises a plurality of assembly units 60. Each assembly unit 60 is arranged near one of the first cavities 56.

In the embodiment shown, each assembly unit 60 includes two front grooves 62, two rear grooves 64 and a pin 66.

The two front grooves 62 are arranged on the front front surface 44 on either side of the first cavity 56 corresponding to the assembly unit 60. Each second cavity 58 on the front surface has a front groove 62 extending therethrough.

The rear grooves 64 are arranged on the rear surface 46, substantially opposite the front grooves. The pin 66 is also arranged on the rear surface 46.

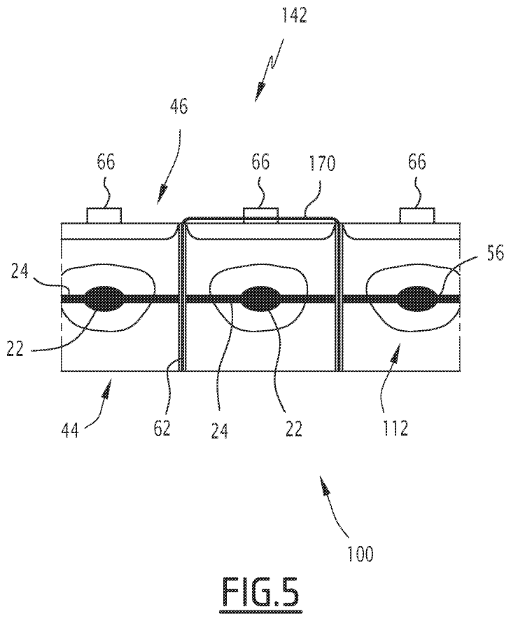

FIG. 5 shows a fitting assembly 100 comprising an orthodontic apparatus 112, an apparatus 142 and a plurality of holding members 170. For simplicity, only one holding member 170 is shown.

The orthodontic apparatus 112 in FIG. 5 corresponds to one embodiment of the orthodontic apparatus 12 defined in the first digitized image 10, previously described, using one or more solid materials. The above description of the orthodontic apparatus 12 applies to the orthodontic apparatus 112 with the same reference numbers.

The one or more solid materials forming the orthodontic apparatus 112 are metal, ceramic or resin, for example. According to one preferred embodiment, the orthodontic apparatus 112 is made of a memory shaped material, such as nitinol. Such an orthodontic apparatus is described in application application FR3089114 in the Applicant's name.

The fitting device 142 of FIG. 5 corresponds to the embodiment of the fitting device 42 defined in the second scanned image 40 previously described, from one or more solid materials,. The above description of the fitting device 42 applies to the laying device 142 with the same reference numbers.

The solid material(s) forming the fitting device 142 are adapted for manufacture by 3D printing or additive manufacturing. Examples of such materials include metal, ceramic or resin.

Each holding member 170 is intended to hold an attachment element 22 of the orthodontic apparatus 112 within the corresponding first cavity 56 of the fitting device 142.

In one joined configuration as shown in FIG. 1, each holding member 170 is joined to the assembly means 48 of the fitting device 142, so as to hold the attachment element 22 within the corresponding first cavity 56.

In the embodiment shown, each holding member 170 is elastic, passing through the front grooves 62 as well as the rear grooves 64 and/or around the pin 66. In a variant embodiment not shown, the holding member 170 is also selected from iron wire, a soluble wire, or any other type of fastener.

Upon passing through a front groove 62, the elastic 170 locks the bridge 24 received in the second cavity 58 through which said front groove passes. Each fastener 22 adjacent to said bridge 24 is thus held in the corresponding first cavity 56.

In a variant, not shown, the holding member is a key that slides into grooves in the assembly unit, for example.

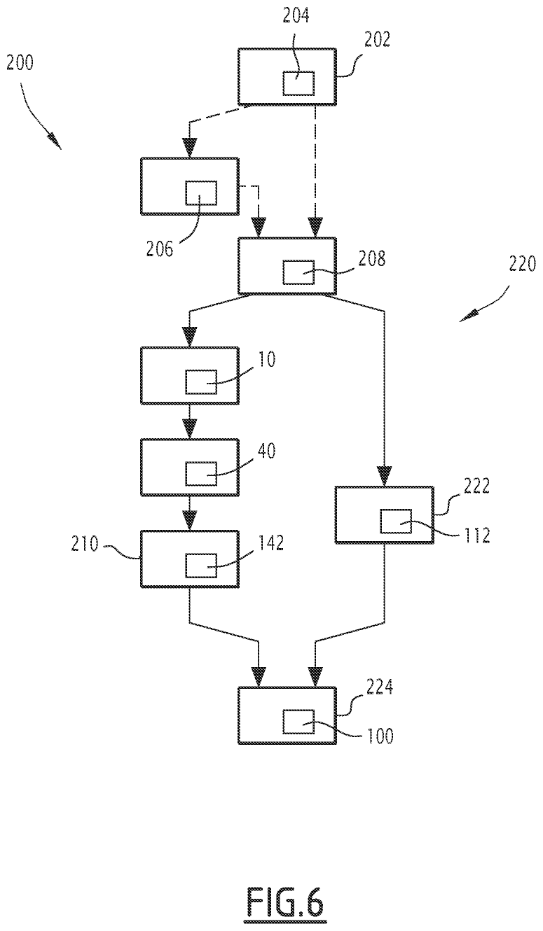

A method 200 for manufacturing the fitting device 142 of FIG. 5 will now be described, with reference to FIG. 6.

In a first step 202, a row of teeth of a patient to be treated is modeled by scanning the jaw of said patient. A digitized image 204 of the row of teeth is obtained. Said digitized image 204 corresponds to the row 14 of teeth in the previously described digitized image 10.

This digitized image 204 corresponds to the patient's teeth of in a first position, known as the initial position.

In a first case, the orthodontic apparatus 12, 112 in question is a so-called active apparatus, having the object of correcting the position of the patient's teeth. In this case, a modified image 206 is made from the digitized image 204 of the teeth in the initial position, using an appropriate software. This modified image 206, or setup, corresponds to a second desired position of the patient's teeth.

In a second case, the orthodontic apparatus 12, 112 in question is a so-called inactive or retainer apparatus, whose object is to retain the the patient's teeth in the first position. In this case, no modified image of the teeth is made.

Then, using appropriate software, a digitized image 208 of an orthodontic apparatus is made from the digitized image 204 of the teeth in the initial position, and possibly from the setup 206. This digitized image 208 includes, the shape and dimensions of the orthodontic apparatus adapted to the patient's teeth and any desired correction, inter alia.

Then, the resulting digitized image 208 is modified and superimposed on the digitized image 204 of the teeth in the initial position. In particular, the shape of the orthodontic apparatus in the image 208 is possibly modified to fit the initial position of the patient's teeth, in the case of an active apparatus.

The previously described digitized image 10 is then obtained, with the orthodontic apparatus 12 joined to the row 14 of teeth.

Then, from the digitized image 10, the digitized image 40 of the fitting device 42 is designed in the manner previously described. In particular, the front surface 44 of the fitting device 42 has portions that are complementary in shape to the tooth receiving surface 20 and to the shape of the orthodontic apparatus 12.

Then, in a manufacturing step 210, the digitized image 40 is transferred to a 3D printer and the fitting device 142 is made by additive manufacturing, using said 3D printer.

A method 220 for manufacturing the fitting assembly 100 of FIG. 5 will also be described with the assistance of of FIG. 6.

In a manufacturing step 222, in parallel to the above-described manufacturing of the fitting device 142, the orthodontic apparatus 112 of FIG. 5 is manufactured from its digitized image 208. For example, said digitized image 208 is transferred to a 3D printer and the orthodontic apparatus 112 is made in one piece by additive manufacturing using said 3D printer. For example, the orthodontic apparatus 112 is made of a shape memory material such as nitinol.

In a variant, the orthodontic apparatus 112 may be made by any known method, such as assembling brackets or beads, forming the attachment elements 22, with an orthodontic arch forming the bridges 24.

Preferably, regardless of the method used to manufacture the orthodontic apparatus 112, the attachment surfaces 30 of the attachment elements 22 are preferably made by 3D printing, to be fully complementary to the receiving areas 34 described above.

Next, in an assembly step 224, the orthodontic apparatus 112 is arranged in the first 56 and second 58 cavities of the front surface 44 of the fitting device 142. Retaining members 170, such as rubber bands, are assembled to the assembly units 60 of the fitting device 142 to hold the orthodontic apparatus 112 in place as described above.

The fitting assembly 100 in an assembled configuration is thus obtained.

A method for implementing the fitting assembly 100 in a mouth of a patient will now be described.

First, with the fitting assembly 100 in the assembled configuration, a fluid resin-like adhesive is applied to the attachment surfaces 30 of the attachment elements 22 of the orthodontic apparatus 112. In a variant, the flowable adhesive is applied to the patient's teeth.

Next, the fitting assembly 100 is inserted into the patient's mouth, so as to press the front surface 44 of the apparatus 142 against the corresponding surface of the patient's teeth. As a result of their design based on the digitized images 10 and 40 described above, the fitting assembly 142 and the orthodontic apparatus 112 fit snugly against the patient's teeth at the level corresponding to the receiving surface 20 previously described.

The fitting assembly 100 is left in place during a period of adhesive curing. The attachment surfaces 30 of the attachment elements 22 are precisely positioned by the fitting assembly 100 so that said attachment elements of the orthodontic apparatus 112 attach precisely to the appropriate locations on the teeth.

Optionally, the fitting assembly 100 and the patient's teeth are exposed to UV radiation to promote curing of the adhesive.

After the adhesive has cured, the elastics 170 are removed or cut and the fitting assembly 142 is removed from the patient's mouth. The orthodontic apparatus 112 is held in place by the adhesive at its desired location on the patient's teeth.

The fitting assembly 100 according to the invention thus allows for easy placement of an orthodontic apparatus 112 in a patient's mouth, with high accuracy of placement of the attachment elements 22.

The invention is compatible with any active or retainer type of orthodontic apparatus, as well as with any method of manufacturing said orthodontic apparatus from a digitized image.

1. A method for manufacturing a fitting device for an orthodontic apparatus, comprising the following steps:
making a first digitized image of a row of teeth of a patient in a first initial position, said row of teeth comprising a receiving surface; and then
making a second digitized image of the orthodontic apparatus, from said first image;
said orthodontic apparatus comprising at least two attachment elements and at least one bridge, the or each bridge connecting two attachment elements,
each attachment element comprising an attachment surface and an opposite front surface, each attachment surface being capable of being joined to a receiving area included in the receiving surface, each receiving area corresponding to a separate tooth in the row;
the method comprising:
making a third digitized image of the orthodontic apparatus joined to the row of teeth in the first initial position from the first and second digitized images, each attachment surface of an attachment element being joined to the corresponding receiving area of the receiving surface; then
making a fourth digitized image of a fitting device for the orthodontic apparatus from the third digitized image, said fitting device comprising: a contact surface capable of being assembled with the receiving surface of the row of teeth; at least two first cavities opening onto the contact surface, each first cavity being complementary to a front surface of an attachment element of the orthodontic apparatus; and at least one second cavity, the or each second cavity being capable of receiving a bridge of the orthodontic apparatus; then
additively manufacturing the fitting device from said fourth digitized image using a solid material.

2. The manufacturing method according to claim 1, further comprising a step of making a fifth digitized image of the patient's row of teeth in a desired second position; the making of the second digitized image of the orthodontic apparatus being made from the first and fifth digitized images, such that the orthodontic apparatus is capable of moving the patient's teeth from the first to the second position.

3. The manufacturing method according to claim 1; wherein the fourth digitized image of the apparatus is configured such that said apparatus comprises a plurality of assembly units, each assembly unit being arranged proximate to a first cavity, each assembly unit being for assembly with a corresponding attachment element in said first cavity.

4. A fitting device for an orthodontic apparatus derived from a method according to claim 1.

5. A method for manufacturing a fitting assembly, said fitting assembly comprising an orthodontic apparatus and a fitting device reversibly joined to each other, the method comprising the steps of:
manufacturing the fitting device by a method according to claim 3;
manufacturing the orthodontic apparatus from the second digitized image; and
assembling said orthodontic apparatus to the fitting device,
wherein the front surface of each attachment element is received in the corresponding first cavity, each bridge is received in the corresponding second cavity.

6. A method for manufacturing a fitting assembly according to claim 5, further comprising assembling a holding member with each assembly unit of the fitting device, said holding member being capable of retaining an attachment element of the orthodontic apparatus in the corresponding first cavity of the fitting device.

7. A fitting assembly for an orthodontic apparatus, derived from a method according to claim 5.

8. The fitting assembly for an orthodontic apparatus according to claim 7, wherein the orthodontic apparatus is a lingual type apparatus for application to the back of a teeth of a patient.

9. The fitting assembly according to claim 7, wherein the orthodontic apparatus is made of a shape memory material.

10. The manufacturing method according to claim 2, wherein the fourth digitized image of the apparatus is configured such that said apparatus comprises a plurality of assembly units, each assembly unit being arranged proximate to a first cavity, each assembly unit being for assembly with a corresponding attachment element in said first cavity.

11. A method for manufacturing a fitting assembly, said fitting assembly comprising an orthodontic apparatus and a fitting device reversibly joined to each other, the method comprising the steps of:
manufacturing the fitting device by a method according to claim 1;
manufacturing the orthodontic apparatus from the second digitized image; and
assembling said orthodontic apparatus to the fitting device,
wherein the front surface of each attachment element is received in the corresponding first cavity, each bridge is received in the corresponding second cavity.

12. A method for manufacturing a fitting assembly, said fitting assembly comprising an orthodontic apparatus and a fitting device reversibly joined to each other, the method comprising the steps of:
manufacturing the fitting device by a method according to claim 2;
manufacturing the orthodontic apparatus from the second digitized image; and
assembling said orthodontic apparatus to the fitting device,
wherein the front surface of each attachment element is received in the corresponding first cavity, each bridge is received in the corresponding second cavity.

13. A method for manufacturing a fitting assembly, said fitting assembly comprising an orthodontic apparatus and a fitting device reversibly joined to each other, the method comprising the steps of:
manufacturing the fitting device by a method according to claim 10;
manufacturing the orthodontic apparatus from the second digitized image; and
assembling said orthodontic apparatus to the fitting device,
wherein the front surface of each attachment element is received in the corresponding first cavity, each bridge is received in the corresponding second cavity.

14. A fitting assembly for an orthodontic apparatus, derived from a method according to claim 6.

15. The fitting assembly according to claim 8, wherein the orthodontic apparatus is made of a shape memory material.

16. The fitting assembly of claim 9, wherein the memory material is nitinol.

17. The fitting assembly of claim 15, wherein the memory material is nitinol.
